(19) United States
(12) Patent Application Publication
(10) Pub. No.: US 2006/0012654 A1
(43) Pub. Date: Jan. 19, 2006

(54) Pigment dispersion with polymeric dispersant

(76) Inventors: Xiaoru Wang, Webster, NY (US); Gary L. House, Victor, NY (US); Mary C. Brick, Webster, NY (US); Paul D. Yacobucci, Rochester, NY (US)

Correspondence Address: Paul A. Leipold;Legal Staff, Eastman Kodak Company, 343 State Street, Rochester, NY, 14650-2201, US

(21) Appl. No.: 10/891,316

(22) Filed: Jul. 14, 2004

(51) Int. Cl. G01D 11/00

(52) U.S. Cl. 347/100

(57) ABSTRACT

The invention provides a pigment dispersion for an ink jet ink composition in which the pigment dispersion contains pigment particles having a median particle size of 200 nm or less, and a random graft copolymer dispersant containing a hydrophilic monomer type, a hydrophobic monomer type having a molecular weight of less than 200, and a macro-monomer type. The invention also provides an aqueous ink jet ink composition and printing method using the pigment dispersion.

### FIELD OF THE INVENTION

This invention relates to a pigment dispersion with polymeric dispersant and pigment nanoparticles. The pigment dispersion is particularly useful in aqueous pigment-based ink compositions for ink jet printing.

### BACKGROUND OF THE INVENTION

Ink jet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand ink jet, individual ink droplets are projected as needed onto the image-recording element to form the desired printed image. Common methods of controlling the projection of ink droplets in drop-on-demand printing include piezoelectric transducers and thermal bubble formation. In another process, known as continuous ink jet, a continuous stream of droplets is charged and deflected in an image-wise manner onto the surface of the image-recording element, while un-imaged droplets are caught and returned to an ink sump. Ink jet printers have found broad applications across markets ranging from desktop document and photographic-quality imaging, to short run printing and industrial labeling.

Ink compositions used in ink jet printers can be classified as either pigment-based in which the colorant exists as pigment particles suspended in the ink composition, or as dye-based in which the colorant exists as a fully-solvated dye species that consists of one of more dye molecules. Pigment-based inks are often preferred over dye-based inks because they render printed images that have better resistance to light and ozone as compared to printed images made with dye-based inks.

Today, virtually all pigment-based ink compositions used in photographic-quality ink jet printing have pigment particles in nanometer-size range. It is well known in the art that when light strikes the surface of a printed image, light scattering occurs if particles at the surface of the printed image are greater than about 300 nm or about the shortest wavelength of visible light. Such light scattering is detrimental because optical density is reduced. As such, pigment-based ink compositions used in today's ink jet printers have pigment particles with average diameters less than about 200 nm. Pigment-based ink compositions having pigment particles with an average diameter of less than about 100 nm are known and are particularly desirable because they not only give high optical densities, but are easy to jet through printheads having small nozzle diameters, for example, less than 25 um.

The process of preparing pigment-based ink compositions usually involves two sequential steps: (a) a milling step to break up crude pigment cake to primary pigment particles, and (b) a formulation step in which the primary pigment particles are diluted with ink components such as water and water-miscible organic compounds to give the final ink composition. In the milling step, the crude pigment cake is typically suspended in a medium that is similar to the final ink composition, and dispersant and milling media are added. Mechanical energy is supplied to this pigment dispersion, and the collisions between the pigment and milling media cause the pigment to deaggregate into its primary particles.

It is well known in the art that the choice of dispersant in the milling step is critical because it facilitates deaggregation and ultimately determines how small the primary pigment particles will be. The dispersant is also critical in maintaining particle stability of the pigment particles both before and after they are formulated to give the final ink composition. The term “particle stability”, as used herein, is often referred in the art as “ink stability”; and refers to the propensity of the primary pigment particles to re-aggregate or flocculate. Flocculation is always a concern because the dispersed state of primary pigment particles is a thermodynamically unstable state, and free energy is minimized as the surface area of the pigment is minimized.

U.S. Pat. No. 5,714,538 relates to polymeric dispersants for pigmented inks used in ink jet printing. These polymeric dispersants are graft copolymers comprising a hydrophilic polymeric segment, a hydrophobic polymeric segment incorporating a hydrolytically-stable siloxyl substituent, and a stabilizing segment such as a reactive surfactant monomer, a protective colloid monomer, or a non-siloxyl hydrophobic monomer.

U.S. Pat. No. 6,652,634 B1 relates to polymeric dispersants for pigmented inks used in ink jet printing. These polymeric dispersants are graft copolymers comprising a hydrophilic polymeric segment, a hydrophobic polymeric segment incorporating a hydrolytically-stable siloxyl substituent, and an additional segment derived from a monomer having a hydrophobic head and a polymeric tail.

U.S. Pat. No. 6,117,921 describes a process for making printed images using pigmented ink jet compositions. The pigments are dispersed with graft copolymers that are block copolymers and are described as having hydrophilic and hydrophobic portions, and either the backbone portion or sidechain portion is hydrophilic and the other portion is hydrophobic.

U.S. Pat. No. 5,589,522 describes an ink composition for ink jet printing having an aqueous carrier and a pigment dispersed with a graft polymer. These dispersants are graft polymers consisting of a backbone of polyacrylic acid onto which hydrophobic side chains are grafted.

JP 06-100810 A describes graft copolymer dispersants used to prepare pigment dispersions for pigment-based ink jet ink compositions. These dispersants consist of hydrophobic parts that are the backbone of the polymer and hydrophilic parts that are grafted on the termini of the backbone.

U.S. Pat. No. 5,679,138; U.S. Pat. No. 5,651,813 and U.S. Pat. No. 5,985,017 describe the preparation of aqueous pigment-based ink compositions for ink jet printing wherein pigment particles are dispersed with surfactants.

None of the aforementioned references describe or suggest the pigment dispersions of the invention, and there remains a need in the art for pigment dispersions having sufficient particle stability for a broad set of ink jet applications.

### SUMMARY OF THE INVENTION

The invention provides a pigment dispersion for an ink jet ink composition in which the pigment dispersion contains pigment particles having a median particle size of 200 nm or less, and a random graft copolymer dispersant containing a hydrophilic monomer type, a hydrophobic monomer type having a molecular weight of less than 200, and a macro-monomer type.

The invention also provides an ink jet ink composition containing a pigment dispersion, water and a water-miscible organic compound; wherein the pigment dispersion contains pigment particles having a median particle size of 200 nm or less, and a random graft copolymer dispersant comprising a hydrophilic monomer type, a hydrophobic monomer type having a molecular weight of less than 200, and a macro-monomer type.

The invention also provides an ink jet printing method having the steps of A) providing an ink jet printer that is responsive to digital data signals; B) loading the printer with an ink jet recording element; C) loading the printer with an ink jet ink composition containing a pigment dispersion, water and a water-miscible organic compound; wherein the pigment dispersion contains pigment particles having a median particle size of 200 nm or less, and a random graft copolymer dispersant containing a hydrophilic monomer type, a hydrophobic monomer type having a molecular weight of less than 200, and a macro-monomer type; and D) printing on the ink jet recording element using the ink jet ink composition in response to the digital data signals.

The invention provides numerous advantages. The invention provides a pigment dispersion wherein the pigment particles have a median diameter of less than 200 nm, such that ink compositions made therefrom render photographic-quality printed images having high optical densities. Furthermore, the invention provides a pigment dispersion wherein the pigment particles exhibit excellent particle stability, i.e., do not re-aggregate or flocculate, when formulated in typical aqueous ink compositions suitable for use in today's ink jet printers, even when such ink compositions are subjected to extreme temperatures over extended periods of time. Pigment dispersions of the invention are also robust in the sense that they can be used in a wide variety of aqueous ink compositions, thereby allowing the ink formulator latitude when designing ink compositions for use with a particular ink jet printer and/or recording element.

The invention also provides ink compositions that are easy to jet through printheads having small nozzle diameters and that do not plug printhead nozzles even after hundreds of pages are printed. As a result, printed images are free of undesirable image artifacts, such as white spots and banding, known to occur when printhead nozzles shut down either temporarily or permanently. Ink compositions of the invention enable extension of printhead lifetime and good storage stability.

Ink compositions of the invention are capable of rendering photographic-quality printed images when printed on a variety of ink jet recording elements, even those having high gloss, and such printed images exhibit long term stability to environmental conditions such as light and ozone. Ink compositions of the invention also provide superior rub resistance even without the addition of polymeric binders to the ink compositions.

### DETAILED DESCRIPTION OF THE INVENTION

The pigment dispersion of the invention consists of pigment particles having a median particle size of 200 nm or less, and a random graft copolymer dispersant comprising a hydrophilic monomer type, a hydrophobic monomer type having a molecular weight of less than 200, and a macro-monomer type. The invention also provides an aqueous ink jet ink composition and printing method using the pigment dispersion. The polymer may comprise one or more of each of the above monomer types.

The dispersants used in the invention are random copolymers in the sense that they are prepared by randomly copolymerizing ethylenically unsaturated monomers via conventional free radical polymerization methods. These random copolymers are distinct from structured copolymers such as block copolymers, and they are easier to prepare than structured copolymers. The dispersants used in the invention are graft copolymers in the sense that side chains are attached at various positions along the backbone of the copolymer. The side chains are part of the macro-monomer type, and so are incorporated into the dispersant during the free radical polymerization process.

The dispersants used in the invention must be hydrophilic enough such that the pigment particles are rendered soluble in the pigment dispersion and the ink composition. However, the dispersants must also be hydrophobic enough such that adequate adsorption onto the pigment particles is obtained and is maintained under extreme temperatures for extended periods of time. These requirements dictate the hydrophilic/hydrophobic balance that a dispersant must exhibit, and the balance differs depending on the particular pigment as well as the components in the ink composition. Therefore, the particular combinations of monomer types and their respective amounts must be chosen accordingly.

The hydrophilic monomer type is an ethylenically unsaturated monomer, of which many are well known in the art and are described in, for example, U.S. Pat. No. 6,652,634 B1; U.S. Pat. No. 6,117,921; U.S. Pat. No. 6,245,832 B1; or U.S. Pat. No. 4,597,794. The hydrophilic monomer type may be hydrophilic due to a variety of functional groups including carboxylic acids, sulfonic acids, alcohols, amines, etc., or combinations thereof. In a preferred embodiment, the hydrophilic monomer type contains a carboxylic acid group because it tends to provide the right hydrophilic/hydrophobic balance for a variety of monomer type combinations. Useful hydrophilic monomer types include acrylic acid, methacrylic acid, ethacrylic acid, itaconic acid, etc., or derivatives thereof, such as any alkyl, aryl, alkylaryl derivatives thereof; acrylamide, methacrylamide, etc., or any alkyl, aryl, alkylaryl secondary or tertiary derivatives thereof; unsaturated diols; triols; tetraols; etc.; or ethylenically unsaturated heterocyclics. Any of these hydrophilic monomer types may be used either individually or in combinations of two or more thereof. The molecular weight of the hydrophilic monomer type is not particularly limited.

The hydrophobic monomer type having a molecular weight of less than 200 is an ethylenically unsaturated monomer, of which many are well known in the art and are described in the aforementioned references. In a preferred embodiment, the hydrophobic monomer type having a molecular weight of less than 200 has an aromatic ring in order to maximize adsorption of the dispersant on the pigment particles. For example, the hydrophobic monomer having a molecular weight of less than 200 is styrene, benzyl acrylate, benzyl methacrylate, 2-phenylethyl methacrylate, alpha-methyl styrene, vinyl toluene, vinyl naphthalene, or derivatives thereof. In another preferred embodiment, the hydrophobic monomer type having a molecular weight of less than 200 may be an alkyl, aryl or alkylaryl derivative of acrylic acid or methacrylic acid. Any of the aforementioned monomer types may have other functional groups such as alcohols, ethers, glycols, etc., in order to obtain the desired hydrophilic/hydrophobic balance. Any of these hydrophobic monomer types having a molecular weight of less than 200 may be used either individually or in combinations of two or more thereof.

The macro-monomer type also contributes to the propensity of the dispersant to adsorb to the pigment particles. The macro-monomer type is an ethylenically unsaturated monomer, of which many are well known in the art and are described in, for example, U.S. Pat. No. 5,714,538; U.S. Pat. No. 6,117,921; or U.S. Pat. No. 6,652,634 B1, incorporated herein by reference. The macro-monomer type is considered an oligomer or polymer with the ethylenically unsaturated group in a terminal or near-terminal position. The macro-monomer may have a variety of functional groups in order to obtain the desired hydrophilic/hydrophobic balance. Examples of useful functional groups include ethers; glycols; siloxyls; alcohols, esters; amines; amides; linear or branched alkyl, aryl or alkylaryl groups; etc.; and are used either individually or in combinations of two or more thereof.

In a preferred embodiment, the macro-monomer type is derivative of acrylic acid or methacrylic acid because they can be readily esterified with a variety of oligomers or polymers. In, another preferred embodiment, the macro-monomer type is a linear or branched siloxane that is hydrolytically stable in that it does not react with water under neutral conditions. The number of siloxane units is not particularly limited, but is typically about 1 to about 50, preferably from about 2 to about 16. The silicone atoms may be functionalized independently with alkyl, aryl, or alkylaryl groups, which may themselves have additional functional groups including ethers, glycols, alcohols, esters, amines, amides, etc. In a preferred embodiment, the silicone atoms are functionalized independently with any of the lower alkyl groups (C1 to C6) or benzyl groups. In an especially preferred embodiment, the macro-monomer type is a monomethacryloxypropyl-terminated polydimethylsiloxane.

The random graft copolymer dispersant may contain one or more additional monomer types that are different from the hydrophilic monomer type, the hydrophobic monomer type having a molecular weight of less than 200, or the macro-monomer type. These one or more additional monomer types may be used to further adjust the hydrophilic/hydrophobic balance, or they may be used to adjust the physical properties. For example, an additional monomer type may be used to adjust the Tg of the random graft copolymer dispersant. The Tg range is typically between −50 and 150 degrees Centigrade. In one embodiment the additional monomer type is hydroxyethyl acrylate.

The relative amounts of the different monomer types in the random graft copolymer dispersants are not particularly limited, however, the inventors have found that some limitations are more useful than others. In a preferred embodiment, the hydrophobic monomer type is present in an amount of 50 weight percent or less of the total weight of the polymeric dispersant. In another preferred embodiment, the macro-monomer type is present in an amount of 40 weight percent or less of the total weight of the polymeric dispersant. Random graft copolymer dispersants made according to these preferred embodiments exhibited excellent performance in terms of solubility and adsorption onto pigment particles.

The random graft copolymer dispersant may have any molecular weight, as long as the ink composition made therefrom provides reliable and stable jetting over extended periods of time. The number average molecular weight is less than 50,000 for piezo drop-on-demand printheads, and less than 15,000 for thermal drop-on-demand printheads which inherently require high temperatures for jetting. The inventors have found that a preferable number average molecular weight is less than 7,000 and more preferably, greater than 500.

In a preferred embodiment of the invention, the random graft copolymer dispersant is derived from the following: the hydrophilic monomer type is methacrylic acid, the hydrophobic monomer type having a molecular weight of less than 200 is styrene, and the macro-monomer type is a monomethacryloxypropyl terminated polydimethylsiloxane. In another preferred embodiment of the invention, the dispersant is derived from the following: the one or more additional monomer types is hydroxyethyl acrylate, the hydrophilic monomer type is methacrylic acid, the hydrophobic monomer type having a molecular weight of less than 200 is benzyl methacrylate, and the macro-monomer type is a monomethacryloxypropyl terminated polydimethylsiloxane. These two dispersants provide superb particle stability.

The pigment particles used in the dispersion of the invention must have a median particle diameter of less than 200 nm. As used herein, median particle size refers to the 50^{th} percentile such that 50% of the volume of the particles is smaller than the indicated size. This small size is necessary so that ink compositions prepared therefrom may be jetted from ink jet printheads having small nozzle sizes, for example, less than 20 microns. In a preferred embodiment, the median particle size is 100 nm or less because ink compositions prepared therefrom may be fired reliably over extended periods of time. Reliable jetting occurs when individual streams of ink droplets can be jetted continuously from each of the printhead nozzles without any nozzles shutting down, either temporarily or permanently. In another preferred embodiment, the median particle size is 50 nm or less because ink compositions prepared therefrom enable reliable jetting for high performance ink jet printing systems.

The pigment dispersion of the invention may be yellow, magenta, cyan, black, gray, red, violet, blue, green, orange, brown, etc., and a wide variety of organic and inorganic pigments, alone or in combination, are well known in the art for producing the desired color. The exact choice of pigments will depend upon the specific application and performance requirements such as color reproduction and image stability.

Pigments suitable for use in the invention include azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212,213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

In a preferred embodiment of the invention, the pigment is C.I. Pigment Blue 15:3, C.I. Pigment Red 122, C.I. Pigment Red 177, C.I. Pigment Red 202, C.I. Pigment Yellow 155, C.I. Pigment Yellow 74, C.I. Pigment Yellow 158, C.I. Pigment Violet 19, C.I. Pigment Violet 23, C.I. Pigment Black 7, or the bis(phthalocyanylalumino)tetraphenyldisiloxane cyan pigment represented by the following formula:
PcAl—O—[SiR₂—O]₂—AlPc
where R is a phenyl group and Pc is unsubstituted. The aforementioned pigments are preferred because they provide better color gamut as compared to those that are not preferred. Particularly useful pigments are disclosed in U.S. Pat. Nos. 5,026,427; 5,086,698; 5,141,556; 5,160,370; and 5,169,436.

The pigment dispersion of the invention may be prepared by any method known in the art of ink jet printing, provided that a median particle size of 200 nm or less is obtainable with the random graft copolymer dispersants of the invention. In general, the pigment dispersion of the invention is prepared by suspending crude pigment cake and the dispersant in an optional liquid medium along with inert milling media such as polymeric beads, glasses, ceramics, metals and plastics as described, for example, in U.S. Pat. No. 5,891,231. The mixture of crude pigment cake is then milled using any type of grinding mill such as a media mill, a ball mill, a two-roll mill, a three-roll mill, a bead mill, and air-jet mill, an attritor, or a liquid interaction chamber. During the milling step, the crude pigment cake is broken up into primary pigment particles, commonly referred to in the art as pigment particles. When the desired particle size is obtained, the inert milling media are removed by filtration, and the resulting filtrate is the pigment dispersion. The weight ratio of polymeric dispersant to pigment particles in the milling step is preferably 0.1:1 to 5:1.

The pigment dispersion of the invention can be used to prepare an ink jet ink composition, often referred to in the art as a pigment-based ink composition. The amount of pigment dispersion used in the ink composition of the invention varies such that the pigment particles are present in an amount of 0.5 to 30 weight percent of the total ink composition. Typically, the amount of pigment particles is 0.5 to 10 weight percent of the total ink composition.

The ink composition of the invention is aqueous-based and contains water and a water-miscible organic compound, often referred to in the art as a humectant and/or co-solvent. This organic compound is used to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5 pentanediol, 1,2-hexanediol, and thioglycol; (3) lower mono- and di-alkyl ethers derived from the polyhydric alcohols; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol. In a preferred embodiment, the ink composition contains an alcohol, a glycol, glycerol, a glycol ether, an amine or mixtures thereof. Typical aqueous-based ink compositions useful in the invention may contain, for example, the following components based on the total weight of the ink: water up to 90%, humectant(s) 5-70%, and co-solvent(s) 2-20%.

Other components present in the ink composition of the invention include surfactants, defoamers, biocides, buffering agents, conductivity enhancing agents, anti-kogation agents, drying agents, waterfast agents, water soluble and water dispersible polymers, chelating agents, light stabilizers, or ozone stabilizers.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. For typical drop-on-demand printheads, viscosities are no greater than 10 cP, and preferably in the range of about 1.0 to 6.0 cP. Continuous type printheads are capable of jetting ink compositions with much higher viscosities, even up to 30 cP. Acceptable surface tensions are no greater than 60 dynes/cm, and preferably in the range of 28 dynes/cm to 45 dynes/cm.

The ink jet ink composition of the invention may be used in an ink jet printing method having the steps of A) providing an ink jet printer that is responsive to digital data signals; B) loading the printer with an ink jet recording element; C) loading the printer with an ink jet ink composition of the invention; and D) printing on the ink jet recording element using the ink jet ink composition in response to the digital data signals. The ink jet recording element used in the method of the invention may be any type used in the art, including but not limited to plain paper, vinyl, canvas, and specialty paper designed specifically for use with ink jet printing.

The following examples are provided to illustrate the invention.

### EXAMPLES

Preparation of Polymeric Dispersants

Polymeric Dispersant 1 (PD-1)

Methacrylic acid (MAA) 35 g, styrene (S) 2.5 g, monomethacryloxypropyl terminated polydimethylsiloxane (MW 900; MA-PDMS) 12.5 g, 1-dodecanethiol 0.5 g, methylene chloride 100 mL, and 2,2′-azo-bis(2-methylpropionitrile)[AIBN] 0.25 g were mixed under nitrogen atmosphere in a 1 L three-necked round bottomed flask equipped with a reflux condenser. The solution was stirred and degassed with nitrogen for 20 minutes. Stirring was continued and the temperature was raised to 70° C. After 24 hours, the resulting solution was cooled and added slowly to hexane with rapid stirring. A white precipitate appeared and was isolated by filtering under suction. A white powder was obtained by drying in vacuo. An aqueous solution of the polymer was prepared by dissolving it in water using potassium hydroxide. The final solution was pH 7 and 20 wt. % polymer.

The number average molecular weight of the resulting polymer was determined by size-exclusion chromatography using a PLGel™ Mixed-B column (Polymer Laboratories) in tetrahydrofuran solvent and calibrated with polystyrene standards having narrow a molecular weight distribution between 580 and 2,300,000. Polymeric Dispersant 1 having MAA/S/MA-PDMS in a 70:5:25 weight ratio was found to have a number average molecular weight of 4200.

Polymeric Dispersant 2 (PD-2)

Methacrylic acid (MAA) 20.0 g, benzyl methacrylate (BM) 20.0 g, monomethacryloxypropyl terminated polydimethylsiloxane (MW 900; MA-PDMS) 7.5 g, and hydroxyethyl acrylate (HEA) 2.5 g, 1-dodecanethiol 0.5 g, methylene chloride 100 mL, and AIBN 0.25 g were mixed under nitrogen atmosphere in a 1 L three-necked round bottomed flask equipped with a reflux condenser. The solution was stirred and degassed with nitrogen for 20 minutes. Stirring was continued and the temperature was raised to 70° C. After 24 hours, the resulting solution was cooled and added slowly to hexane with rapid stirring. A white precipitate appeared and was isolated by filtering under suction. A white powder was obtained by drying in vacuo. An aqueous solution of the polymer was prepared by dissolving it in water using potassium hydroxide. The final solution was pH 7 and 20 wt. % polymer. Polymeric Dispersant 2 having MAA/BM/MA-PDMS/HEA in a 40:40:15:5 weight ratio was found to have a number average molecular weight of 3780.

Comparative Polymeric Dispersant 1 (CPD-1)

Methacrylic acid (MAA) 22.6 g, stearyl methacrylate (SM) 3.0 g, monomethacryloxypropyl terminated polydimethylsiloxane (MW 900; MA-PDMS) 7.9 g, 1-dodecanethiol 2.06 g, isopropyl alcohol 100 ml, and AIBN 0.64 g were mixed under nitrogen atmosphere in a 1 L three-necked round bottomed flask equipped with a reflux condenser. The solution was stirred and degassed with nitrogen for 20 minutes. Stirring was continued and the temperature was raised to 70° C. After 24 hours, the resulting solution was cooled and added slowly to hexane with rapid stirring. A white precipitate appeared and was isolated by filtering under suction. A white powder was obtained by drying in vacuo. An aqueous solution of the polymer was prepared by dissolving it in water using potassium hydroxide. The final solution was pH 7 and 20 wt. % polymer. Comparative Polymeric Dispersant 1 having MAA/SM/MA-PDMS in a 68:9:23 weight ratio was found to have a number average molecular weight of 4170.

Preparation and Evaluation of Pigment Dispersions

Magenta Pigment Dispersion 1 of the Invention (M-1)

A mixture of 250 g of polymeric beads having mean diameter of 50 μm, 25.0 g of Pigment Red 122 (Sun Chemical Corp.), 62.5 g of a 20 wt. % solution of PD-1 (12.5 g of PD-1) was prepared and diluted with water to give a total of 525 g. The mixture was milled for one hour at 1000 RPM using a Premier Mill 2500HV laboratory dispersator equipped with a 3.8 cm (1.5 in.) Cowles blade, and then for an additional 23 hours at 2500 RPM while holding the temperature of the mixture constant at 23 degrees Centigrade. The mixture was then allowed to set for 12 hours. Milling media were removed by filtering the mixture through a 10 micron screen under vacuum into a glass flask. The filtrate was then filtered through a one micron binder-free glass fiber filter (Pall Corp.) to obtain M-1 having approximately 10 wt. % pigment. The ratio of polymer:pigment was approximately −1:2.

The median particle size of M-1 was measured using a Microtrac® Ultrafine Particle Analyzer 150 from Microtrac, Inc. As used herein, median particle size refers to the 50^{th} percentile such that 50% of the volume of the particles is smaller than the indicated size. The median particle size for M-1 was 60 nm.

Control Magenta Pigment Dispersion (CM-1)

CM-1 was prepared the same as M-1 except that 6.25 g of potassium oleoylmethyltaurate (KOMT) was used instead of PD-1. The median particle size for CM-1 was 14 nm. The ratio of KOMT: polymer was approximately 1:4. The median particle size for CM-1 was 14 nm.

Additional inventive pigment dispersions were prepared as described for M-1, except that different pigments were used. For C-2, the pigment was bis(phthalocyanylalumino)tetraphenyldisiloxane cyan pigment (brAlPc) represented by the following formula:
PcAl—O—[SiR₂—O]₂—AlPc

where R is a phenyl group and Pc is unsubstituted. Additional comparative pigment dispersions were prepared as described for CM-1, except that different pigments were used. Each of the inventive pigment dispersions was evaluated for particle stability by incubating samples at 60 degrees Centigrade for four weeks and then remeasuring the median particle size. The particular pigments used and the resulting data are summarized in Table 1.

TABLE 1

| Pigment | | | | After 4 |
|---|---|---|---|---|
| Dispersion | Pigment | Dispersant | Initial | Weeks |
| M-1 | Pigment Red | PD-1 | 60 | 52 |
| | 122 | | | |
| M-2 | Pigment Red | PD-2 | 16 | 17 |
| | 122 | | | |
| Y-1 | Pigment | PD-2 | 48 | 60 |
| | Yellow 97 | | | |
| Y-2 | Pigment | PD-2 | 15 | NM |
| | Yellow 155 | | | |
| Y-3 | Pigment | PD-2 | 10 | 11 |
| | Yellow 74 | | | |
| C-1 | Pigment Blue | PD-2 | 54 | NM |
| | 15:3 | | | |
| C-2 | brAlPc | PD-2 | 118 | NM |
| Control | Pigment Red | KOMT | 14 | NM |
| CM-1 | 122 | | | |
| Control | Pigment | KOMT | 18 | NM |
| CY-1 | Yellow 155 | | | |
| Control | Pigment Blue | KOMT | 25 | NM |
| CC-1 | 15:3 | | | |

*NM = not measured

The data in Table 1 show that the pigment dispersions of the invention have median particle sizes less than 200 nm, and that pigment particles dispersed with the polymeric dispersants of the invention provide median particle sizes that are comparable to the control pigment dispersions. Table 1 also shows that the pigment dispersions of the invention exhibit excellent particle stability when subjected to extreme temperatures over extended periods of time.

Preparation and Evaluation of Ink Compositions

Ink compositions were prepared using the pigment dispersions described above. The ink compositions consisted of pigment dispersion at pigment 2.5 wt. %, diethylene glycol at 12 wt. %, and Surfynol® 465 (Air Products and Chemicals, Inc.) at 0.3 wt. %. Particle stability for each of the ink compositions were evaluated and were found to be comparable to those of the corresponding pigment dispersions in that little or no change in particle size was found after four weeks.

Although the invention has been described in detail with reference to certain preferred embodiments for the purpose of illustration, it is to be understood that variations and modifications can be made by those skilled in the art without departing from the spirit and scope of the invention.

What is claimed is:

1. A pigment dispersion for an ink jet ink composition, the pigment dispersion comprising pigment particles having a median particle size of 200 nm or less, and a polymeric dispersant comprising a random graft copolymer comprising a hydrophilic monomer type, a hydrophobic monomer type having a molecular weight of less than 200, and a macro-monomer type.

2. The pigment dispersion of claim 1 wherein the pigment particles have a median particle size of 100 nm or less.

3. The pigment dispersion of claim 1 wherein the hydrophilic monomer type comprises a carboxylic acid group.

4. The pigment dispersion of claim 1 wherein the hydrophilic monomer type comprises acrylic acid, methacrylic acid or derivatives thereof.

5. The pigment dispersion of claim 1 wherein the hydrophobic monomer type comprises an aromatic ring.

6. The pigment dispersion of claim 4 wherein the hydrophobic monomer type comprises an aromatic ring.

7. The pigment dispersion of claim 1 wherein the hydrophobic monomer type comprises styrene, benzyl acrylate, benzyl methacrylate, 2-phenylethyl methacrylate, alpha-methyl styrene, vinyl toluene, vinyl naphthalene, or derivatives thereof.

8. The pigment dispersion of claim 1 wherein the hydrophobic monomer type comprises a derivative of acrylic acid or methacrylic acid.

9. The pigment dispersion of claim 6 wherein the hydrophobic monomer type comprises styrene, benzyl acrylate, benzyl methacrylate, 2-phenylethyl methacrylate, alpha-methyl styrene, vinyl toluene, vinyl naphthalene, or derivatives thereof.

10. The pigment dispersion of claim 6 wherein the macro-monomer type comprises a derivative of acrylic acid or methacrylic acid.

11. The pigment dispersion of claim 1 wherein the macro-monomer type comprises a siloxane.

12. The pigment dispersion of claim 6 wherein the macro-monomer type comprises a derivative of acrylic acid or methacrylic acid.

13. The pigment dispersion of claim 12 wherein the macro-monomer type comprises a siloxane.

14. The pigment dispersion of claim 1 wherein the hydrophobic monomer type is present in an amount of 50 weight percent or less of the total weight of the polymeric dispersant.

15. The pigment dispersion of claim 1 wherein the macro-monomer type is present in an amount of 40 weight percent or less of the total weight of the polymeric dispersant.

16. The pigment dispersion of claim 1 wherein the hydrophilic monomer type is methacrylic acid, the hydrophobic monomer type having a molecular weight of less than 200 is styrene, and the macro-monomer type is a monomethacryloxypropyl-terminated polydimethylsiloxane.

17. The pigment dispersion of claim 1 wherein the random graft copolymer comprises one or more additional monomer types which are different from the hydrophilic monomer type, the hydrophobic monomer type having a molecular weight of less than 200, or the macro-monomer type.

18. The pigment dispersion of claim 17 wherein the one or more additional monomer types is hydroxyethyl acrylate, the hydrophilic monomer type is methacrylic acid, the hydrophobic monomer type having a molecular weight of less than 200 is benzyl methacrylate, and the macro-monomer type is a monomethacryloxypropyl-terminated polydimethylsiloxane.

19. The pigment dispersion of claim 1 wherein the polymeric dispersant has a number average molecular weight of less than 50,000.

20. The pigment dispersion of claim 1 wherein the polymeric dispersant has a number average molecular weight of less than 15,000.

21. The pigment dispersion of claim 1 wherein the polymeric dispersant has a number average molecular weight of less than 7,000.

22. The pigment dispersion of claim 1 wherein the polymeric dispersant has a number average molecular weight of greater than 500.

23. The pigment dispersion of claim 1 wherein the pigment particles are C.I. Pigment Blue 15:3, C.I. Pigment Red 122, C.I. Pigment Red 177, C.I. Pigment Red 202, C.I. Pigment Yellow 155, C.I. Pigment Yellow 74, C.I. Pigment Yellow 158, C.I. Pigment Violet 19, C.I. Pigment Violet 23, C.I. Pigment Black 7, or the bis(phthalocyanylalumino)tetraphenyldisiloxane cyan pigment represented by the following formula:
PcAl—O—[SiR₂—O]₂—AlPc
where R is a phenyl group and Pc is unsubstituted.

24. The pigment dispersion of claim 1 having a weight ratio of polymeric dispersant to pigment particles of 0.1:1 to 5:1.

25. An ink jet ink composition comprising a pigment dispersion, water and a water-miscible organic compound; wherein the pigment dispersion comprises pigment particles having a median particle size of 200 nm or less, and a polymeric dispersant comprising a random graft copolymer comprising a hydrophilic monomer type, a hydrophobic monomer type having a molecular weight of less than 200, and a macro-monomer type.

26. The ink composition of claim 25 wherein the pigment particles comprise 0.5 to 30 weight percent of the total ink composition.

27. The ink composition of claim 25 wherein water is present in an amount of up to 90 weight percent of the total ink composition.

28. The ink composition of claim 25 wherein the water-miscible organic compound is an alcohol, a glycol, glycerol, a glycol ether, an amine or mixtures thereof.

29. The ink composition of claim 25 wherein the hydrophilic monomer type is comprises acrylic acid, methacrylic acid or derivatives thereof, the hydrophobic monomer type having a molecular weight of less than 200 is comprises an aromatic ring, and the macro-monomer type comprises a derivative of acrylic acid or methacrylic acid, and a siloxane.

30. The ink composition of claim 25 wherein the hydrophilic monomer type is methacrylic acid, the hydrophobic monomer type having a molecular weight of less than 200 is styrene, and the macro-monomer type is monomethacryloxypropyl terminated polydimethylsiloxane.

31. The ink composition of claim 25 wherein the random graft copolymer comprises one or more additional monomer types which are different from the hydrophilic monomer type, the hydrophobic monomer type having a molecular weight of less than 200, or the macro-monomer type.

32. The ink composition of claim 31 wherein the one or more additional monomer types is hydroxyethyl acrylate, the hydrophilic monomer type is methacrylic acid, the hydrophobic monomer type having a molecular weight of less than 200 is benzyl methacrylate, and the macro-monomer type is monomethacryloxypropyl terminated polydimethylsiloxane.

33. An ink jet printing method comprising the steps of:
A) providing an ink jet printer that is responsive to digital data signals;
B) loading the printer with an ink jet recording element;
C) loading the printer with an ink jet ink composition comprising a pigment dispersion, water and a water-miscible organic compound; wherein the pigment dispersion comprises pigment particles having a median particle size of 200 nm or less, and a polymeric dispersant comprising a random graft copolymer comprising a hydrophilic monomer type, a hydrophobic monomer type having a molecular weight of less than 200, and a macro-monomer type; and
D) printing on the ink jet recording element using the ink jet ink composition in response to the digital data signals.
